(19) United States
(12) Patent Application Publication
(10) Pub. No.: US 2012/0272757 A1
(43) Pub. Date: Nov. 1, 2012

(54) DRIVE DEVICE IN A WINDSHIELD WIPER UNIT OF A VEHICLE

(75) Inventors: Burak Barlas, Baden-Baden (DE); Achim Kraus, Buehl (DE)

(73) Assignee: ROBERT BOSCH GMBH, Stuttgart (DE)

(21) Appl. No.: 13/504,961

(22) PCT Filed: Aug. 30, 2010
(86) PCT No.: PCT/EP10/62608

§ 371 Date: Jul. 16, 2012

(30) Foreign Application Priority Data
Oct. 30, 2009 (DE) 10 2009 046 203.1

(51) Int. Cl. F16H 21/18

(52) U.S. Cl. 74/47

(57) ABSTRACT

A drive device in a windshield wiper unit comprises a crank arm (4), which is connected via a connecting element (5) made of plastic to a wiper shaft (3). The connecting element (5) is molded both to the crank arm (4) and to a connecting section (3A) of the wiper shaft (3), wherein the crank arm (4) is only connected via the connecting element (5) to the wiper shaft (3).

### BACKGROUND OF THE INVENTION

The invention relates to a drive device in a windshield wiper unit of a vehicle.

A drive device in a windshield wiper unit is known from the German patent publication DE 10 2006 027 345 A1. The drive device comprises a drive arm or more precisely a crank arm, which is driven by a drive motor via a linkage and which is rotationally coupled to a wiper shaft that receives a wiper arm. A connecting element, which is embodied as a plastic molded part, is disposed between the crank arm and the wiper shaft. The connecting element serves to fasten the wiper arm to the wiper shaft, however not for the transmission of power or rather torque which occurs via a direct contact between crank arm and wiper shaft. In so doing, the crank arm has a recess with a wavelike or polygon-like cross-section, through which the wiper shaft is guided, wherein a sufficient frictional or positive-locking connection for transmitting the required torques should be provided via the wave or polygon shape which engages on a knurled section of said wiper shaft. The plastic connecting element serves merely to axially secure the crank arm at the wiper shaft by an annular bead on the inside of the sleeve-shaped connecting element engaging in a positive-locking manner in a radial groove on the circumferential surface of said wiper shaft.

### SUMMARY OF THE INVENTION

The aim underlying the invention is to design a drive device in a windshield wiper unit using simple design features in such a manner that the drive device escapes damage during impact with a pedestrian, wherein a sufficient power or rather torque transmission is at the same time ensured in said drive device during regular operation.

The drive device according to the invention is a component of a windshield wiper unit in a motor vehicle, with which the windshield or the rear window of the vehicle can be cleaned. The drive device comprises a crank arm, which is typically driven via a crank linkage from an electric drive motor, as well as a wiper shaft, which is the carrier of the wiper arm and which is set into a torsional pendular movement by the crank arm. The power or rather torque transmitting connection between the crank arm and the wiper shaft only results via a connecting element made of plastic, which is molded both to the crank arm and to a connecting section of the wiper shaft. No further connecting measures between crank arm and wiper shaft are required, which exceed the plastic connecting element. Most importantly, the torque or rather power transmission in both the rotational and axial direction takes place exclusively via said connecting element.

In this way, a power or rather torque transmitting connection is achieved using simple measures. As a result, the driving motion of the wiper arm is ensured on the one hand with sufficient reliability during regular operation of the windshield wiper unit and on the other hand is ensured in the form of pedestrian impact protection in the event of an impact by a pedestrian. The axial connection between wiper shaft and crank arm is thereby disengaged for the purpose of implementing an immersion movement of the drive device, such that the wiper shaft including the wiper arm supported thereon axially move back. Two functions can thus be attributed to the connecting element: firstly the torque transmission from the crank arm to the wiper shaft for the driving motion of the wiper arm and secondly the safety function, wherein said crank arm and said wiper shaft are released from one another in the event of a defined axial force taking place in the axial direction. Both functions are achieved with the same connecting element; whereas in the case of prior art, another frictional or positive-locking coupling directly between crank arm and wiper shaft is required in addition to said connecting element. The embodiment according to the invention is constructively designed in a simpler manner with respect to prior art without limiting the functionality thereof.

Because the plastic connecting element is not only molded to the crank arm but also additionally to the wiper arm, a fixed connection results in the axial direction, which is released when a certain force level is exceeded. The force level is influenced on the one hand by the surface of the connecting section on the wiper shaft, whereat the plastic connecting element engages. It can, for example, therefore be useful to provide the surface of said connecting section with knurling in order to achieve better adhesion of the material of said connecting element to said wiper shaft by means of an increased roughness in the circumferential surface of said connecting section. In this way, the axial force as well as the torque about the wiper shaft axis, which is transmitted by the crank arm, is increased.

On the other hand, it is additionally or alternatively possible to provide a positive-locking element on the circumferential surface of the wiper shaft, to which the molded connecting element is connected in a positive-locking manner at least in the axial direction and if need be also in the peripheral direction. Provision is made in a simple embodiment for the positive-locking element to be embodied as an annular groove, which is introduced into the circumferential surface of the wiper shaft. As a result of molding the connecting element to said wiper shaft, the annular groove is filled with material of said connecting element, whereby an undercut results in the axial direction between wiper shaft and connecting element and an increased axial force level can be set. The parameters determining the annular groove, as, e.g., the radial constriction of said annular groove as well as the axial extension thereof, are factors with regard to the force level which can be transmitted between crank arm and wiper shaft without releasing the connection thereof. In order to ensure the axial force leads to a desired release of the connection between connecting element and wiper shaft when a threshold value is exceeded, the diameter of said annular groove in the region of the groove base is at least 95% of the diameter of the connecting section of said wiper shaft. It is thus ensured that the radial constriction of said annular groove does not exceed a certain amount. Furthermore, the axial extension of said annular groove can be limited, for example, to double the amount of said radial constriction of said annular groove.

The crank arm is preferably provided with a receiving opening for receiving the wiper shaft, wherein said wiper shaft projects through the receiving opening in the assembled state; however, the power transmission between crank arm and wiper shaft takes place via the molded connecting element in the axial direction as well as in the rotational direction and not directly between crank arm and wiper shaft. It therefore suffices to provide a sufficiently large receiving opening in the crank arm for the wiper shaft without having to provide a cross-section exactly fitted to said wiper shaft. It is thus particularly an option for the receiving opening to have a different cross-sectional shape than said wiper shaft in the region of the connecting section, wherein said receiving opening has, for example, an angular, in particular a square, cross-section and said connecting section on said wiper shaft has a round cross-section. The connecting and retention forces between crank arm and wiper shaft are applied via the connecting element.

It can be useful for a protection cap, which completely or partially encompasses the wiper shaft in the peripheral direction, to be provided on the connecting element for preventing the ingress of water or dirt into the wiper bearing. The protection cap has, for example, a cylindrical geometry, wherein basically other geometrical forms are also possible as, for example, a square geometry. A wall or a plurality of walls of the protection cap advantageously lies radially spaced apart from the circumferential surface of the wiper shaft.

### BRIEF DESCRIPTION OF THE DRAWINGS

Further advantages and advantageous embodiments can be extracted from the additional claims, the description of the figures and the drawings. The following are shown:

FIG. 1 a drive device in a windshield wiper unit of a motor vehicle, said drive device having a wiper shaft for receiving a wiper arm and having a crank arm, via which the wiper shaft is driven, wherein the connection between crank arm and wiper shaft takes place via a plastic connecting element,

FIG. 2 the drive device according to FIG. 1 having the wiper shaft in an axially displaced position,

FIG. 3 a sectional view through the drive device,

FIG. 4 a sectional enlargement of the region in FIG. 3 which is encircled with a a dashed-and-dotted line,

FIG. 5 a perspective view of the drive device,

FIG. 6 a perspective view of a drive device in a further embodiment variant, in which the connecting element between crank arm and wiper shaft has approximately the shape of an ashlar,

FIGS. 8 to 10 individual depictions of the wiper shaft, the crank arm and the connecting element of the drive device according to FIG. 7.

In the figures, the same components are provided with the same reference numerals.

### DETAILED DESCRIPTION

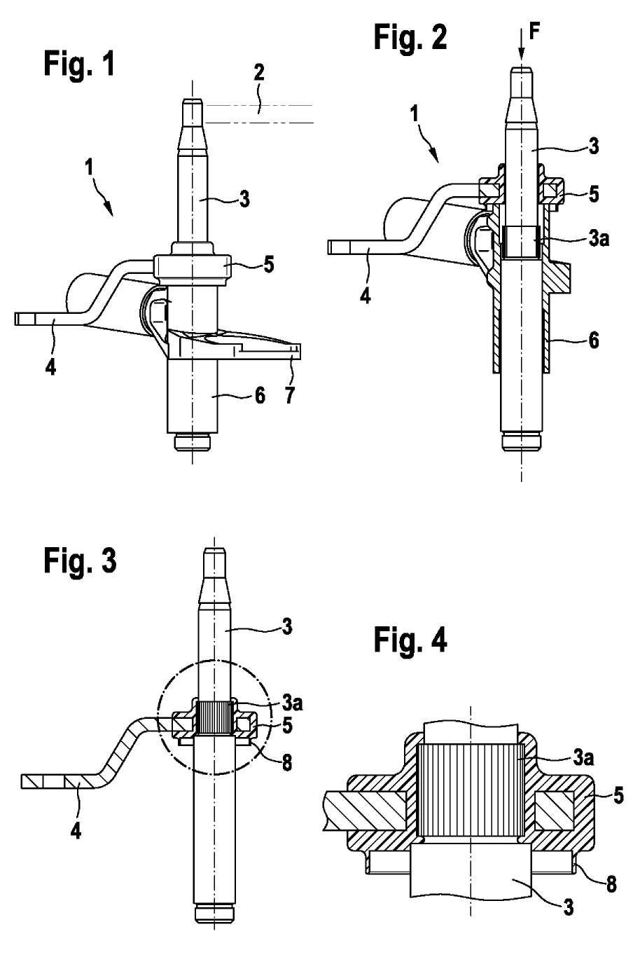

A drive device 1 in a windshield wiper unit in a motor vehicle is depicted in FIG. 1, said drive device being used to drive a wiper arm 2, which rests on a vehicle window, in particular the windshield or the rear window of the vehicle, and can be set into a torsional pendular movement. The wiper arm 2 is held in a rotatably fixed manner on the front face of a wiper shaft 3, which is driven by an electric drive motor via a crank arm 4. The crank arm 4 is coupled to the wiper shaft 3 via a plastic connecting element 5 in a rotatably fixed manner as well as fixedly in the axial direction. Said wiper shaft 3 is accommodated in a fastening sleeve 6 which is held on a wiper rod assembly 7 or is embodied as a single piece with a component of said wiper rod assembly. The fastening sleeve 6 is configured open on both front faces and the axial fixation of said wiper shaft 3 takes place exclusively via the crank arm 4 and the connecting element 5.

The drive device 1 is shown in the regular operating position in FIG. 1. In the event an axial force F, which exceeds a threshold value, for example, when impact occurs with a pedestrian, acts on the front face of the wiper shaft 3 which faces the wiper arm, said wiper shaft 3 then axially releases from the connecting element 5 and is axially displaced in the fastening sleeve 6 accomodating said shaft. In this way, a pedestrian impact protection system can be implemented.

As can be seen in FIG. 2, a connecting section 3a of the wiper shaft 3 is spaced axially apart from the plastic connecting element 5 in the axially displaced position.

It follows from FIG. 3 that the plastic connecting element 5, which is configured at least approximately disk-shaped and has a central recess for the wiper shaft, is connected in the regular operating position to the wiper shaft in the region of the connecting section 3a. Said connecting section 3a has a cylindrical form and has a knurled circumferential surface, whereby the adhesion of said connecting element 5 is improved on said connecting section 3a. Said connecting element 5 comprises an injection-moldable plastic and is molded to said connecting section 3a of the wiper shaft 3 as well as to the crank arm 4. The connection between crank arm 4 and wiper shaft 3 takes place exclusively via said connecting element 5. The crank arm 4 likewise comprises a receiving opening, through which said wiper shaft 3 is guided, wherein the receiving opening 4 is dimensioned larger than said wiper shaft 3 in the region of said connecting section 3a, wherein the material of said connecting element completely fills the remaining space between the circumferential surface of said connecting section 3a and the inside of the receiving opening in said crank arm 4. Drive torques about the longitudinal axis 3, which are produced using said crank arm 4, as well as axial retention forces are transmitted via said connecting element 5.

As can be extracted from FIG. 3 in combination with the enlarged depiction pursuant to FIG. 4, the connecting element 5 has a protection cap 8 on the front face thereof, which is disposed on the side of said connecting element which faces away from the wiper arm and is embodied as a single piece with said connecting element. The protection cap 8 is configured in the shape of a collar and has a cylindrical shape. Said protection cap 8 lies radially spaced apart from the circumferential surface of the wiper shaft 3 and serves to prevent the ingress of water and dirt into the wiper bearing.

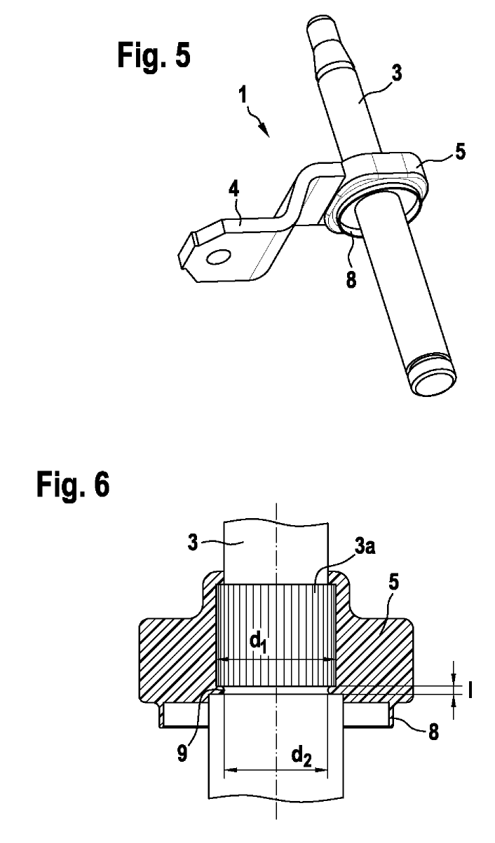

The cylindrical shape of the protection cap 8 as well as the larger diameter of said protection cap in comparison to the wiper shaft is also illustrated in the perspective depiction pursuant to FIG. 5.

As is illustrated in the depiction pursuant to FIG. 6, an annular groove 9 axially adjoins the connecting section 3a of the wiper shaft 3, said groove having the function of improving the connection between wiper shaft 3 and connecting element 5 by producing a positive-locking closure. When the connecting element 5 is molded, plastic material flows into the annular groove 9, whereby an undercut is provided in the axial direction and the separation forces, which are required to release said wiper shaft 3 from said connecting element 5 in the axial direction, are accordingly increased. The axial separation forces are a function of the geometry of said annular groove 9, in particular of the axial length 1 as well as the diameter d₂ in the region of the groove base in relation to the diameter d₁ of the connecting section 3a. In order to limit said axial separation forces to a defined amount, it is useful for the diameter d₂ of said annular groove 9 to comprise a minimum value of the diameter d₁ of said connecting section 3a, for example a value amounting to at least 95% thereof. Furthermore, the axial length of said annular groove 9 is limited, for example, to twice that of the radial depth or the constriction of said annular groove, wherein the radial constriction corresponds to the difference between the diameters d₁ and d₂.

The annular groove 9 is located on the side axially opposite to the wiper arm and directly adjoins the connecting section 3a.

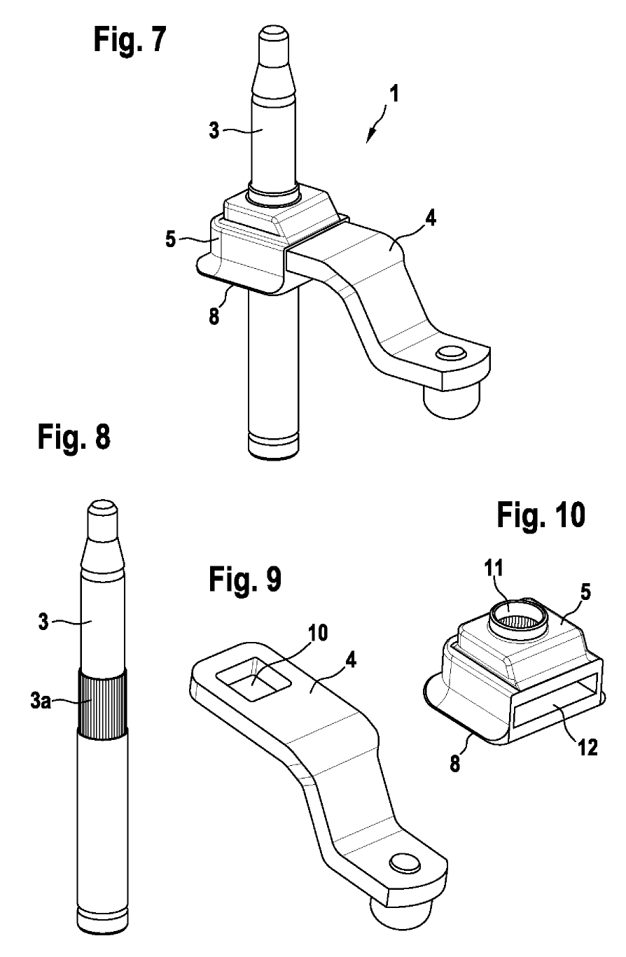

A further exemplary embodiment for a drive device 1 is depicted in FIG. 7. FIGS. 8 to 10 show the wiper shaft 3, the crank arm 4 as well as the connecting element 5 of the drive device from FIG. 1. Said connecting element 5 has at least approximately the shape of an ashlar, and the protection cap 8 accordingly consists of straight sections, which extend along a front face of the connecting section 5. The walls of said protection cap 8 lie radially spaced apart from the circumferential surface of the wiper shaft 3, said walls being outwardly inclined at an angle with respect to the longitudinal axis of the wiper shaft.

The connecting element 5 comprises a central recess 11, which extends in the axial direction, for receiving the wiper shaft 3 as well as a radial insertion opening 12 for receiving a section of the crank arm 4. The connecting element 5 is molded both to the wiper shaft 3 in the region of the connecting section 3a and to the section of the crank arm 4 on the front face thereof. Said crank arm 4 is provided with a central receiving opening 10, through which the wiper shaft 3 is passed. The receiving opening 10 has a cross-sectional geometry which deviates from that of the wiper shaft 3. In the exemplary embodiment, said receiving opening 10 has a square cross-section, which is, however, dimensioned sufficiently large to receive the cylindrical wiper shaft 3. The spaces between the inner walls of said receiving opening 10 and the circumferential surface of the connecting section 3a of said wiper shaft 3 are filled with the material of the connecting element 5.

1. A drive device in a windshield wiper unit of a motor vehicle, said drive device comprising a crank arm (4) which is connected to a wiper shaft (3) via a molded connecting element (5) made of plastic, characterized in that the connecting element (5) is molded both to the crank arm (4) and to a connecting section (3a) of the wiper shaft (3) in such a way that said crank arm (4) is only connected via said connecting element (5) to said wiper shaft (3).

2. The drive device according to claim 1, characterized in that the connecting section (3a) of the wiper shaft (3) is cylindrical in shape.

3. The drive device according to claim 1, characterized in that the connecting section (3a) of the wiper shaft (3) is provided with knurling.

4. The drive device according to claim 1, characterized in that a positive-locking element (9), to which the molded connecting element (5) is connected in an axial direction in a positive-locking manner, is integrally molded to a circumferential surface of the wiper shaft (3).

5. The drive device according to claim 4, characterized in that the positive-locking element is embodied as an annular groove (9) on the wiper shaft (3).

6. The drive device according to claim 5, characterized in that a diameter of the annular groove (9) in a region of a groove base exceeds a minimum value for a diameter of the connecting section (3a) of the wiper shaft (3).

7. The drive device according to claim 5, characterized in that the an axial length of the annular groove (9) does not exceed a maximum value for a radial depth of said annular groove (9).

8. The drive device according to claim 1, characterized in that the crank arm has a receiving opening (10) for receiving the wiper shaft (3) wherein power transmission between the crank arm (4) and the wiper shaft (3) takes place via the molded connecting element (5).

9. The drive device according to claim 8, characterized in that the receiving opening (10) has a square cross-section.

10. The drive device according to claim 1, characterized in that a protection cap (8) encompassing the wiper shaft (3) is integrally molded to the connecting element (5).

11. The drive device according to claim 10, characterized in that the protection cap (8) is disposed at a radial distance from a circumferential surface of the wiper shaft (3).

12. (canceled)

13. The drive device according to claim 2, characterized in that the connecting section (3a) of the wiper shaft (3) is provided with knurling.

14. The drive device according to claim 13, characterized in that a positive-locking element (9), to which the molded connecting element (5) is connected in an axial direction in a positive-locking manner, is integrally molded to a circumferential surface of the wiper shaft (3).

15. The drive device according to claim 14, characterized in that the positive-locking element is embodied as an annular groove (9) on the wiper shaft (3).

16. The drive device according to claim 15, characterized in that a diameter of the annular groove (9) in a region of a groove base exceeds a minimum value for a diameter of the connecting section (3a) of the wiper shaft (3).

17. The drive device according to claim 16, characterized in that an axial length of the annular groove (9) does not exceed a maximum value for a radial depth of said annular groove (9).

18. The drive device according to claim 17, characterized in that the crank arm has a receiving opening (10) for receiving the wiper shaft (3) wherein power transmission between the crank arm (4) and the wiper shaft (3) takes place via the molded connecting element (5).

19. The drive device according to claim 18, characterized in that the receiving opening (10) has a square cross-section.

20. The drive device according to claim 19, characterized in that a protection cap (8) encompassing the wiper shaft (3) is integrally molded to the connecting element (5).

21. The drive device according to claim 20, characterized in that the protection cap (8) is disposed at a radial distance from a circumferential surface of the wiper shaft (3).
